(19) United States
(12) Patent Application Publication
(10) Pub. No.: US 2026/0023240 A1
(43) Pub. Date: Jan. 22, 2026

(54) OPTICAL ELEMENT DRIVING MECHANISM

(71) Applicant: TDK CORPORATION, Tokyo (JP)

(72) Inventors: Chuan-Min LEE, Taoyuan City (TW); Chao-Chang HU, Taoyuan City (TW); Shu-Shan CHEN, Taoyuan City (TW); Pai-Jui CHENG, Taoyuan City (TW)

(21) Appl. No.: 18/777,945

(22) Filed: Jul. 19, 2024

(51) Int. Cl. G02B 7/08; G02B 27/64

(52) U.S. Cl. CPC G02B 7/08; G02B 27/646

(57) ABSTRACT

An optical element driving mechanism is provided. The optical element driving mechanism includes a fixed assembly, a movable part, and a driving assembly. The fixed assembly has a main axis. The movable part is configured to be connected to an optical element, and the movable part is movable relative to the fixed assembly. The driving assembly is configured to drive the movable part to move relative to the fixed assembly.

### BACKGROUND OF THE INVENTION

### Field of the Disclosure

The present disclosure relates to an optical element driving mechanism, and in particular it relates to an optical element driving mechanism with a piezoelectric element.

### Description of the Related Art

As technology has developed, many of today's electronic devices (such as smartphones) have been equipped with cameras to provide photographic and video functionality. Users can capture photographs and record videos using the camera modules disposed in their electronic devices.

Today's design of electronic devices continues to follow the trend of miniaturization, meaning that the various components of the camera module and its structure must also be continuously reduced, so as to achieve miniaturization. In general, a driving mechanism in a camera module has a camera lens holder configured to hold a camera lens, and the driving mechanism can have the functions of auto focusing or optical image stabilization. However, although the existing driving mechanism can achieve the aforementioned functions of taking photographs and recording videos, they still cannot meet all users' needs.

Therefore, how to design a camera module that can perform autofocus, optical anti-shake and achieve miniaturization at the same time is topic nowadays that needs to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism is provided. The optical element driving mechanism includes a fixed assembly, a movable part, and a driving assembly. The fixed assembly has a main axis. The movable part is configured to be connected to an optical element, and the movable part is movable relative to the fixed assembly. The driving assembly is configured to drive the movable part to move relative to the fixed assembly.

According to some embodiments, the optical element driving mechanism further includes an accommodation space configured to accommodate at least a portion of the driving assembly. The accommodation space has a first opening formed on a first surface. The accommodation space has a second opening formed on a second surface. The first surface and the second surface are located on the fixed assembly. The first surface and the second surface face different directions. The first surface and the second surface are not parallel to each other. When viewed along a first axis, the first surface overlaps at least a portion of the driving assembly. When viewed along a second axis, the second surface does not overlap the driving assembly. The first axis is perpendicular to the second axis.

According to some embodiments, the first opening is connected to the second opening. The first opening has a first narrow portion with a tapered structure. The second opening has a second narrow portion with a tapered structure. When viewed along the first axis, the second narrow portion overlaps at least a portion of the driving assembly. When viewed along the first axis, the first narrow portion overlaps at least a portion of the driving assembly. The first narrow portion is connected to the second narrow portion.

According to some embodiments, the accommodation space has a setting portion. The driving assembly is disposed on the setting portion and is located in a preset position. The setting portion has a planar structure. The setting portion is parallel to the first surface.

According to some embodiments, the accommodation space further has a first guiding portion configured to guide the driving assembly to be located in the preset position. The first guiding portion is adjacent to the setting portion. The first guiding portion has a first planar structure, and the first planar structure is not parallel to the setting portion. The first guiding portion is not perpendicular to the setting portion.

According to some embodiments, the accommodation space further has a second guiding portion configured to guide the driving assembly to be located in the preset position. The second guiding portion is adjacent to the setting portion. The second guiding portion has a second planar structure, and the second planar structure is not parallel to the setting portion. The second guiding portion is not perpendicular to the setting portion. The first guiding portion and the second guiding portion are not parallel to each other. The first guiding portion and the second guiding portion are not perpendicular to each other. The optical element is not located in the accommodation space.

According to some embodiments, the driving assembly includes a driving element, a transmission element, and an enhancing element. The driving element is configured to generate a driving force. The transmission element is configured to transmit the driving force. The driving force is transmitted to the movable part through the transmission element. The transmission element has a long strip-shaped structure extending along the main axis. The enhancing element corresponds to the driving element to enhance the intensity of the driving force. When viewed along the first axis, the first surface overlaps at least a portion of the transmission element. When viewed along the second axis, the second surface does not overlap at least a portion of the transmission element.

According to some embodiments, the optical element driving mechanism further includes a first adhesive element, and the driving assembly is connected to the setting portion via the first adhesive element. The first adhesive element is in direct contact with the first guiding portion. The first adhesive element is in direct contact with the second guiding portion. The first adhesive element is in direct contact with the enhancing element.

According to some embodiments, the optical element driving mechanism further includes a second adhesive element, and the driving assembly is connected to the first opening via the second adhesive element. The second adhesive element is in direct contact with the first surface. The second adhesive element is in direct contact with the first narrow portion. The second adhesive element is in direct contact with the transmission element. The first surface is not perpendicular to the extending direction of the transmission element.

According to some embodiments, the optical element driving mechanism further includes a third adhesive element, and the driving assembly is connected to the fixed assembly through the third adhesive element. The third adhesive element is in direct contact with a first adhesive portion of the fixed assembly. The first adhesive portion has a planar structure and faces the driving assembly. The third adhesive element is in direct contact with a second adhesive portion of the driving assembly. The second adhesive portion has a planar structure facing the first adhesive portion. The first adhesive portion and the second adhesive portion are not parallel to each other.

According to some embodiments, the optical element driving mechanism further includes a central assembly disposed between the transmission element and the movable part. The driving force is transmitted to the movable part through the transmission element and the central assembly in sequence. The central assembly includes a contact member which corresponds to the driving assembly. The central assembly further includes a force-applying member which applies a supporting force on the contact member.

According to some embodiments, the force-applying member has a first extending outward portion which is disposed between the contact member and the movable part. The force-applying member further has a second extending outward portion which is disposed between the contact member and the movable part. The force-applying member further has an extending inward portion, and the first extending outward portion is connected to the second extending outward portion via the extending inward portion. The maximum distance between the first extending outward portion and the movable part is different from the minimum distance between the extending inward portion and the movable part. The maximum distance between the first extending outward portion and the movable part is less than the minimum distance between the extending inward portion and the movable part.

According to some embodiments, the optical element driving mechanism further includes a fourth adhesive element. The central assembly is connected to the movable part via the fourth adhesive element. The fourth adhesive element is in direct contact with the force-applying member. The fourth adhesive element is in direct contact with the extending inward portion. At least a portion of the fourth adhesive element is located in a gap formed between the extending inward portion and the movable part.

According to some embodiments, the first adhesive element and the second adhesive element are made of the same material. The second adhesive element and the third adhesive element are made of the same material. The third adhesive element and the fourth adhesive element are made of the same material. The first adhesive element and the fourth adhesive element are made of the same material.

According to some embodiments, the driving assembly further includes a fifth adhesive element and a sixth adhesive element. The transmission element is connected to the driving element via the fifth adhesive element. The enhancing element is connected to the driving element via the sixth adhesive element. The Young's modulus of the fifth adhesive element is the same as the Young's modulus of the sixth adhesive element. The Young's modulus of the fifth adhesive element is different from the Young's modulus of the first adhesive element. The Young's modulus of the fifth adhesive element is greater than the Young's modulus of the first adhesive element.

According to some embodiments, the optical element driving mechanism further includes a circuit assembly. The driving assembly is electrically connected to the circuit assembly and is electrically connected to an external circuit through the circuit assembly. The circuit assembly includes a first electrical connection portion and a second electrical connection portion. The first electrical connection portion is configured to be connected to a first circuit portion of the driving assembly. The second electrical connection portion is configured to be connected to a second circuit portion of the driving assembly. A first section of the first circuit portion is located on a third surface. A second section of the first circuit portion is located on a fourth surface. The second section is located on a fifth surface. The third surface, the fourth surface and the fifth surface are located on the fixed assembly. The third surface and the fourth surface are perpendicular to each other.

According to some embodiments, when viewed along the second axis, the third surface and the fifth surface do not overlap each other. When viewed along the second axis, the second surface and the fourth surface do not overlap each other. The first electrical connection portion and the second electrical connection portion each have a planar structure. When viewed in a direction parallel to the first electrical connection portion, the first electrical connection portion is parallel to the second electrical connection portion. The first electrical connection portion is parallel to the second surface and the fourth surface. When viewed along the second axis, the first electrical connection portion is located between the second surface and the fourth surface. The second surface, the third surface and the fourth surface form a step structure.

According to some embodiments, the optical element driving mechanism further includes a protective element which is disposed on the fixed assembly. The protective element has a columnar structure extending along the main axis. The protective element is configured to pass through the movable part. When viewed along the main axis, with the main axis as the origin, a first quadrant, a second quadrant, a third quadrant and a fourth quadrant are defined. When viewed along the main axis, the protective element and the transmission element are located in the fourth quadrant.

According to some embodiments, the optical element driving mechanism further includes a guiding element which is disposed at the fixed assembly. The guiding element has a columnar structure extending along the main axis. The guiding element is configured to pass through the movable part. The optical element driving mechanism further includes a first stabilizing element which is disposed on the movable part. The first stabilizing element has magnetic material. The first stabilizing element corresponds to the guiding element.

According to some embodiments, when viewed along the main axis, the guiding element and the first stabilizing element are located in the second quadrant. When viewed along the main axis, the movable part has a rectangular structure. When viewed along the main axis, the guiding element and the first stabilizing element are located at a corner of the rectangular structure. When viewed along the main axis, the first stabilizing element, the guiding element and the transmission element are arranged along a diagonal line of the rectangular structure in sequence.

The present disclosure provides an optical element driving mechanism which includes a fixed assembly, a movable part, and a driving assembly. The movable part is movable relative to the fixed assembly, and the driving assembly is configured to drive the movable part to move relative to the fixed assembly. Moreover, the optical element driving mechanism further includes an accommodation space configured to accommodate at least a portion of the driving assembly.

In some embodiments, the accommodation space has a setting portion, a first guiding portion, and a second guiding portion. The setting portion is connected between the first guiding portion and the second guiding portion, and the first guiding portion and the second guiding portion can be inclined surfaces, thereby guiding the driving assembly to be smoothly positioned and affixed to the setting portion.

In addition, the optical element driving mechanism may further include a first adhesive element configured to connect the enhancing element of the driving assembly to the setting portion, and the optical element driving mechanism may further include a second adhesive element which is disposed in the first opening of the base and is configured to connect the transmission element of the driving assembly to the base. Based on the setting of these adhesive elements, not only can the driving assembly be accurately positioned on the base, but also the impact force applied to the driving assembly can be absorbed when the optical element driving mechanism is impacted, so as to prevent the transmission element from being damaged.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optical element driving mechanism 100 according to an embodiment of the present disclosure.

FIG. 2 is an exploded diagram of the optical element driving mechanism 100 according to an embodiment of the present disclosure.

FIG. 3 is a cross-sectional view of the optical element driving mechanism 100 along line A-A in FIG. 1 according to an embodiment of the present disclosure.

FIG. 4 is an enlarged three-dimensional view of a partial structure of the optical element driving mechanism 100 according to an embodiment of the present disclosure.

FIG. 5 is a top view of a partial structure of the optical element driving mechanism 100 according to an embodiment of the present disclosure.

FIG. 6 is a perspective view of a partial structure of the optical element driving mechanism 100 according to an embodiment of the present disclosure.

FIG. 7 is a cross-sectional view of a partial structure of the optical element driving mechanism 100 along the line B-B in FIG. 1 according to an embodiment of the present disclosure.

FIG. 8 is a front view of a partial structure of the optical element driving mechanism 100 according to an embodiment of the present disclosure.

FIG. 9 is a perspective view of a partial structure of the optical element driving mechanism 100 in another view according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

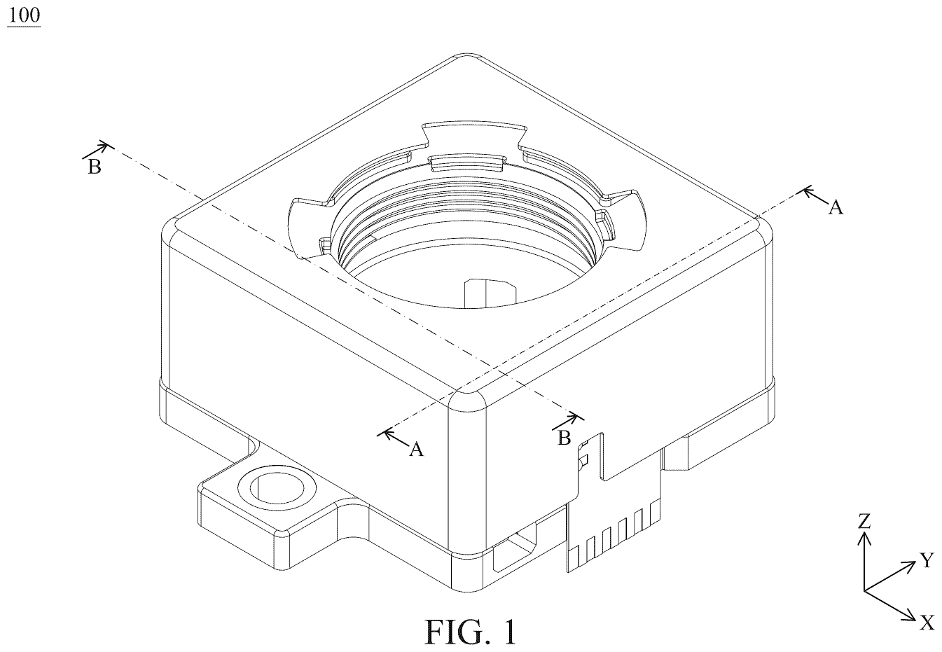

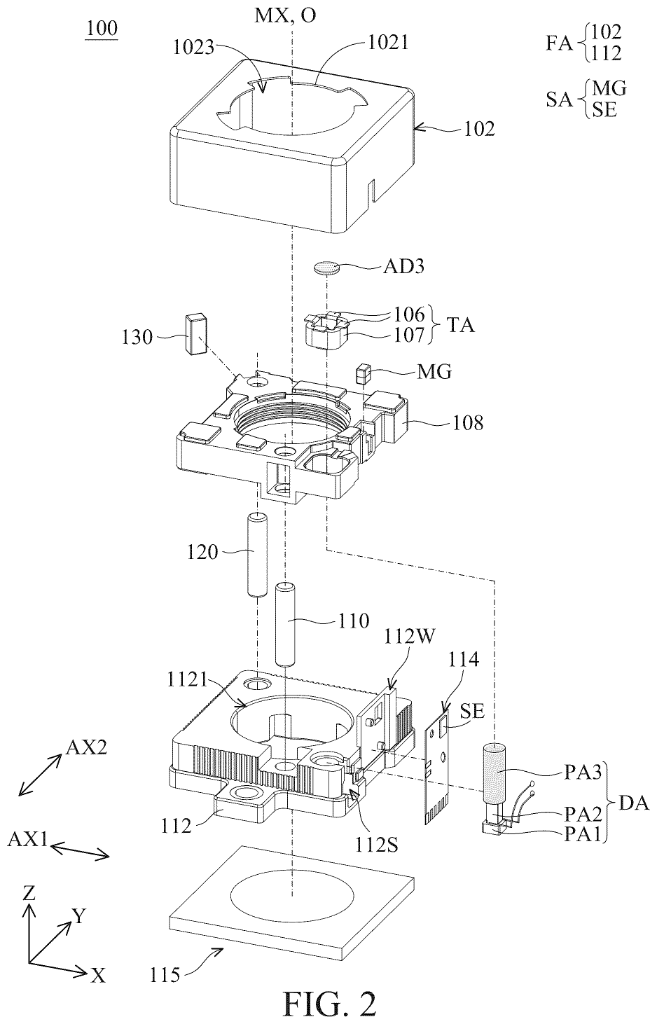

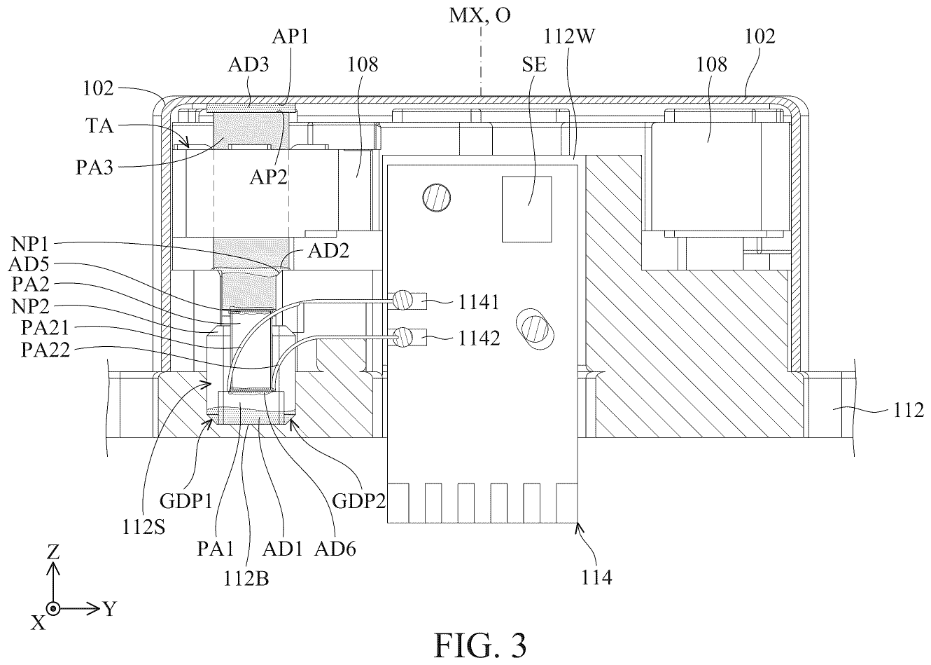

Please refer to FIG. 1 to FIG. 3. FIG. 1 is a schematic diagram of an optical element driving mechanism 100 according to an embodiment of the present disclosure, FIG. 2 is an exploded diagram of the optical element driving mechanism 100 according to an embodiment of the present disclosure, and FIG. 3 is a cross-sectional view of the optical element driving mechanism 100 along line A-A in FIG. 1 according to an embodiment of the present disclosure. The optical element driving mechanism 100 can be an optical camera system and can be configured to hold and drive an optical element (such a camera lens, not shown in figures). The optical element driving mechanism 100 can be installed in various electronic devices or portable electronic devices, such as a smartphone, for allowing a user to perform the image capturing function. In this embodiment, the optical element driving mechanism 100 can be with an auto-focusing (AF) function, but it is not limited thereto. In other embodiments, the optical element driving mechanism 100 can also perform the functions of auto-focusing and optical image stabilization (OIS).

In this embodiment, the optical element driving mechanism 100 may include a fixed assembly FA, a movable part 108, and a driving assembly DA. The movable part 108 is configured to hold the aforementioned optical element (such as an optical lens, not shown in the figures), and the movable part 108 is movable relative to the fixed assembly FA. The driving assembly DA is configured to drive the movable part 108 to move relative to the fixed assembly FA.

In this embodiment, as shown in FIG. 2, the fixed assembly FA includes a casing 102 and a base 112. The casing 102 has a hollow structure, and a casing opening 1021 is formed on it. A base opening 1121 is formed on the base 112, the center of the casing opening 1021 corresponds to an optical axis O of the optical element, and the base opening 1121 corresponds to a photosensitive assembly 115 which is disposed below the base 112. External light can enter the casing 102 through the casing opening 1021 and to be received by the aforementioned photosensitive assembly 115 after passing through the optical element and the base opening 1121 so as to generate a digital image signal. The photosensitive assembly 115 may, for example, be an image sensor, but it is not limited thereto.

Furthermore, the casing 102 and the base 112 are arranged along a main axis MX, and the casing 102 is disposed on the base 112. The main axis MX can overlap or be parallel to the optical axis O. The casing 102 may have an accommodation space 1023 for accommodating components such as the movable part 108 and the driving assembly DA, and so on.

For example, the optical element driving mechanism 100 may further include a circuit assembly 114 which is fixedly disposed a side wall 112W of the base 112, and a portion of the circuit assembly 114 is accommodated in the accommodation space 1023. The circuit assembly 114 may, for example, be a circuit board, but it is not limited thereto. For example, the circuit assembly 114 may be a flexible circuit board.

In this embodiment, as shown in FIG. 2 and FIG. 3, the driving assembly DA is electrically connected to the circuit assembly 114 and can operate according to the control signal of the circuit assembly 114 to drive the movable part 108 to move along the main axis MX or optical axis O.

Specifically, as shown in FIG. 2 and FIG. 3, the driving assembly DA may include an enhancing element PA1, a driving element PA2, a transmission element PA3 and a central assembly TA. The transmission element PA3 can have a long strip-shaped structure (such as a column structure), and the transmission element PA3 may be made of a carbon material, but they are not limited thereto.

The enhancing element PA1 can be, for example, a counterweight, but it is not limited thereto. In other embodiments, the enhancing element PA1 can also be a spring sheet. The driving element PA2 is, for example, a piezoelectric element, fixedly connected between the enhancing element PA1 and the transmission element PA3. In this embodiment, the driving element PA2 is made of a ceramic material, but it is not limited thereto.

The driving element PA2 is configured to generate a driving force, the enhancing element PA1 corresponds to the driving element PA2 to enhance the intensity of the driving force, and the transmission element PA3 is configured to transmit the driving force. The aforementioned driving force can be transmitted to the movable part 108 through the transmission element PA3 to drive the movable part 108 to move along the main axis MX so as to achieve the purpose of autofocus.

Furthermore, the central assembly TA corresponds to the transmission element PA3, and the central assembly TA is disposed between the transmission element PA3 and the movable part 108. As shown in FIG. 2 and FIG. 3, the transmission element PA3 passes through the central assembly TA and the movable part 108, and the movable part 108 clamps the transmission element PA3 through the central assembly TA. Therefore, the driving force can be transmitted to the movable part 108 through the transmission element PA3 and the central assembly TA in sequence.

As shown in FIG. 2, the central assembly TA may include two contact members 106, corresponding to the transmission element PA3 of the driving assembly DA and contacting the transmission element PA3. The central assembly TA may further include a force-applying member 107 which applies a supporting force on the two contact members 106. In this embodiment, the contact member 106 is, for example, a metal spring sheet, and the force-applying member 107 is, for example, a rubber sleeve, but they are not limited thereto.

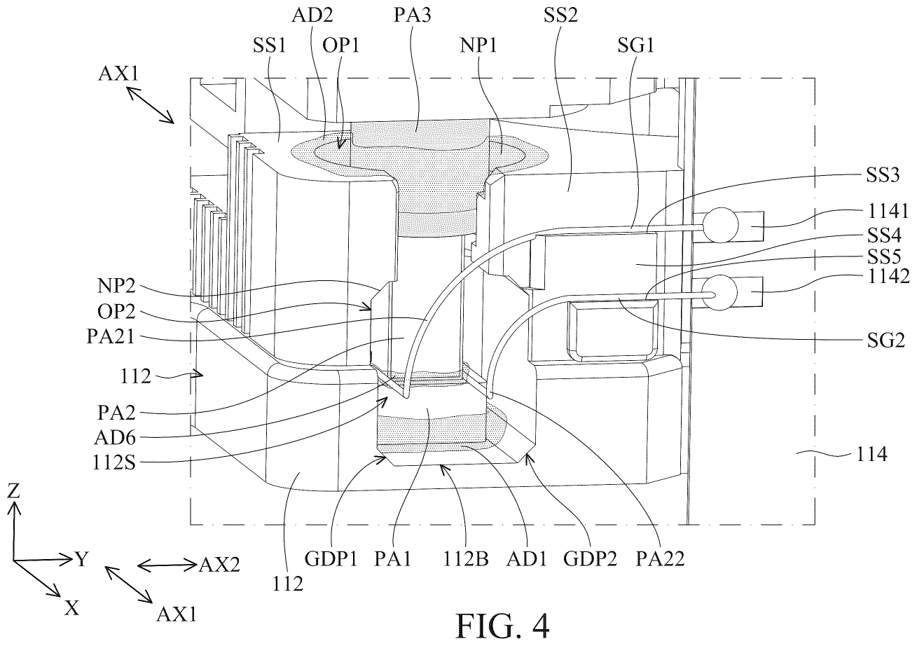

Next, please continue to refer to FIG. 2 to FIG. 4. FIG. 4 is an enlarged three-dimensional view of a partial structure of the optical element driving mechanism 100 according to an embodiment of the present disclosure. As shown in FIG. 3 and FIG. 4, the optical element driving mechanism 100 further includes an accommodation space 112S configured to accommodate at least a portion of the driving assembly DA.

As shown in FIG. 4, the accommodation space 112S may have a first opening OP1 formed on a first surface SS1. Specifically, the first opening OP1 is recessed from the first surface SS1 toward the −Z axis. On the other hand, the accommodation space 112S may have a second opening OP2 formed on a second surface SS2. Specifically, the second opening OP2 is recessed from the second surface SS2 toward the −X axis.

In this embodiment, the first surface SS1 and the second surface SS2 are located on the base 112 of the fixed assembly FA, and the first surface SS1 and the second surface SS2 face different directions. For example, the first surface SS1 faces the +Z-axis, and the second surface SS2 faces the +X-direction, so that the first surface SS1 and the second surface SS2 are not parallel to each other.

When viewed along a first axis AX1, the first surface SS1 overlaps at least one portion of the driving assembly DA. Specifically, when viewed along the first axis AX1, the first surface SS1 overlaps at least one portion of the transmission element PA3.

Furthermore, when viewed along a second axis AX2, the second surface SS2 does not overlap the driving assembly DA. Specifically, when viewed along the second axis AX2, the second surface SS2 does not overlap at least one portion of the transmission element PA3.

The first axis AX1 is, for example, parallel to the X-axis, the second axis AX2 is, for example, parallel to the Y-axis, and the first axis AX1 is perpendicular to the second axis AX2.

In this embodiment, the first opening OP1 is connected to the second opening OP2, and the first opening OP1 may have a first narrow portion NP1 with a tapered structure tapering along the −Z axis. Similarly, the second opening OP2 may also have a second narrow portion NP2 with a tapered structure tapering along the +Z-axis.

As shown in FIG. 4, when viewed along the first axis AX1, the second narrow portion NP2 overlaps at least one portion of the driving assembly DA, such as overlapping the driving element PA2.

When viewed along the first axis AX1, the first narrow portion NP1 overlaps at least one portion of the driving assembly DA, such as overlapping the transmission element PA3. In addition, because the first opening OP1 is connected to the second opening OP2, the first narrow portion NP1 is also connected to the second narrow portion NP2.

Furthermore, as shown in FIG. 3 and FIG. 4, the accommodation space 112S further has a setting portion 112B, and the driving assembly DA is configured to be disposed on the setting portion 112B and is located in a preset position (or referred to as a fixed position), as shown in FIG. 3 and FIG. 4.

In this embodiment, the setting portion 112B may be a planar structure, and the setting portion 112B is a portion of the base 112. The setting portion 112B may be parallel to the first surface SS1.

Furthermore, the accommodation space 112S may further have a first guiding portion GDP1 configured to guide the driving assembly DA to be located in the preset position. The first guiding portion GDP1 is adjacent to the setting portion 112B, and the first guiding portion GDP1 may be a first planar structure. In this embodiment, the first planar structure is not parallel to the setting portion 112B, and the first guiding portion GDP1 is not perpendicular to the setting portion 112B.

Similarly, the accommodation space 112S further has a second guiding portion GDP2 configured to guide the driving assembly DA to be located in the preset position. The second guiding portion GDP2 is adjacent to the setting portion 112B, and the second guiding portion GDP2 may be a second planar structure. The second planar structure is not parallel to setting portion 112B, and the second guiding portion GDP2 is not perpendicular to setting portion 112B.

In addition, the first guiding portion GDP1 and the second guiding portion GDP2 are not parallel to each other, and the first guiding portion GDP1 and the second guiding portion GDP2 are not perpendicular to each other. The first guiding portion GDP1 and the second guiding portion GDP2 may be, for example, inclined surfaces. The minimum distance between the first guiding portion GDP1 and the second guiding portion GDP2 may be equal to or greater than the width of the driving assembly DA. Therefore, when the operator puts the driving assembly DA into the second opening OP2, the enhancing element PA1 can be guided to the setting portion 112B by gravity and by the first guiding portion GDP1 and the second guiding portion GDP2, so as to achieve the purpose of quick installation and positioning.

In addition, it is worth noting that the aforementioned optical element is carried by the movable part 108, and the optical element is not located in the accommodation space 112S.

Please continue to refer to FIG. 3 to FIG. 4. In this embodiment, the optical element driving mechanism 100 may further include a first adhesive element AD1, and the driving assembly DA is connected to the setting portion 112B via the first adhesive element AD1. Specifically, the driving assembly DA is affixed to the setting portion 112B through the first adhesive element AD1.

In this embodiment, the first adhesive element AD1 is in direct contact with the first guiding portion GDP1, the first adhesive element AD1 is in direct contact with the second guiding portion GDP2, and the first adhesive element AD1 is in direct contact with the enhancing element PA1.

Furthermore, as shown in FIG. 4, the optical element driving mechanism 100 may further include a second adhesive element AD2, and the driving assembly DA is connected to the first opening OP1 via the second adhesive element AD2. The second adhesive element AD2 is in direct contact with the first surface SS1, the second adhesive element AD2 is in direct contact with the first narrow portion NP1, and the second adhesive element AD2 is in direct contact with the transmission element PA3.

In addition, it is worth noting that due to assembly tolerances, when the driving assembly is installed in the accommodation space 112S through the first adhesive element AD1 and the second adhesive element AD2, the first surface SS1 may differ be not perpendicular to the extending direction of the transmission element PA3. For example, the angle formed between the first surface SS1 and the transmission element PA3 may be greater than 90 degrees and less than 95 degrees.

Based on such a configuration, the transmission element PA3 can produce a lateral thrust on the movable part 108, and this thrust can improve the problem of tilting of the movable part 108 during movement, making its movement process more stable.

Next, as shown in FIG. 3, the optical element driving mechanism 100 further includes a third adhesive element AD3, and the driving assembly DA is connected to the casing 102 of the fixed assembly FA through the third adhesive element AD3. The third adhesive element AD3 is in direct contact with a first adhesive portion AP1 of the fixed assembly FA.

The first adhesive portion AP1 is, for example, the inner wall surface of the casing 102 and has a planar structure which faces the driving assembly DA. Correspondingly, the third adhesive element AD3 is in direct contact with a second adhesive portion AP2 of the driving assembly DA. The second adhesive portion AP2 is, for example, the top surface of the transmission element PA3 and has a planar structure which faces the first adhesive portion AP1.

As mentioned above, due to assembly tolerances, after the driving assembly DA is installed through the plurality of adhesive elements, the first adhesive portion AP1 and the second adhesive portion AP2 may not be parallel to each other. For example, the angle formed between the first adhesive portion AP1 and the second adhesive portion AP2 may be greater than 0 degree and less than 5 degrees.

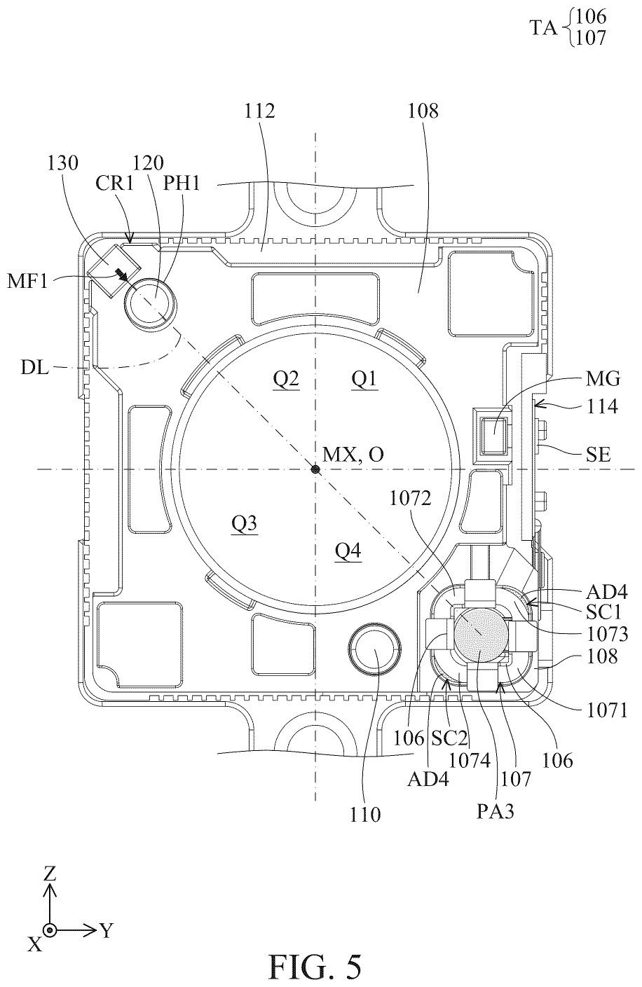

Next, please refer to FIG. 2 to FIG. 5. FIG. 5 is a top view of a partial structure of the optical element driving mechanism 100 according to an embodiment of the present disclosure. As shown in FIG. 5, the force-applying member 107 has a first extending outward portion 1071, which is disposed between the contact member 106 in the lower right corner and the movable part 108. The force-applying member 107 may have a second extending outward portion 1072, which is disposed between the contact member 106 in the upper left corner and the movable part 108.

Furthermore, the force-applying member 107 further has an extending inward portion 1073, and the first extending outward portion 1071 is connected to the second extending outward portion 1072 via the extending inward portion 1073. As shown in FIG. 5, the maximum distance between the first extending outward portion 1071 and the movable part 108 is different from the minimum distance between the extending inward portion 1073 and the movable part 108.

For example, the maximum distance between the first extending outward portion 1071 and the movable part 108 is about 0 to 0.1 mm. That is, the first extending outward portion 1071 is in direct contact with the movable part 108 and there may be no gap between them.

The minimum distance between the extending inward portion 1073 and the movable part 108 is greater than 0.1 mm, such as 0.5 mm. Therefore, the maximum distance between the first extending outward portion 1071 and the movable part 108 is less than the maximum distance between the extending inward portion 1073 and the movable part 108. Similarly, the first extending outward portion 1071 can be connected to the second extending outward portion 1072 via another extending inward portion 1074, and the minimum distance between the extending inward portion 1074 and the movable part 108 is also greater than 0.1 mm.

In this embodiment, the optical element driving mechanism 100 may further include a fourth adhesive element AD4, and the central assembly TA is connected to the movable part 108 via the fourth adhesive element AD4.

The fourth adhesive element AD4 is in direct contact with the force-applying member 107, and a portion of the fourth adhesive element AD4 is in direct contact with the extending inward portion 1073. Similarly, another portion of the fourth adhesive element AD4 is in direct with the extending inward portion 1074.

Specifically, as shown in FIG. 5, at least a portion of the fourth adhesive element AD4 is located in a gap SC1 formed between the extending inward portion 1073 and the movable part 108, and another portion of the fourth adhesive element AD4 is located in a gap SC2 formed between the extending inward portion 1074 and the movable part 108, so that the force-applying member 107 can be connected to the movable part through the fourth adhesive element AD4.

In this embodiment, the first adhesive element AD1 may be made of the same material as the second adhesive element AD2, the second adhesive element AD2 may be made of the same material as the third adhesive element AD3, the third adhesive element AD3 may be made of the same material as the fourth adhesive element AD3, and the first adhesive element AD1 may be made of the same material as the fourth adhesive element AD4.

For example, these adhesive elements can be elastic glue, such as gel, but they are not limited thereto. These adhesive elements may have the same physical properties, such as the same Young's modulus and other properties.

In addition, as shown in FIG. 3 and FIG. 4, the driving assembly DA may further include a fifth adhesive element AD5 and a sixth adhesive element AD6. The transmission element PA3 is connected to the driving element PA2 via the fifth adhesive element AD5, and the enhancing element PA1 is connected to the driving element PA2 via the sixth adhesive element AD6.

In this embodiment, the fifth adhesive element AD5 and the sixth adhesive element AD6 can also be glue. The Young's modulus of the fifth adhesive element AD5 is the same as the Young's modulus of the sixth adhesive element AD6, but the Young's modulus of the fifth adhesive element AD5 is different from the Young's modulus of the first adhesive element AD1. For example, the Young's modulus of the fifth adhesive element AD5 is greater than the Young's modulus of the first adhesive element AD1.

That is, the fifth adhesive element AD5 and the sixth adhesive element AD6 are harder than the first adhesive element AD1, so that the driving element PA2 can be fixedly connected to the enhancing element PA1 and the transmission element PA3.

In addition, it should be noted that in order to clearly show the positions of the fifth adhesive element AD5 and the sixth adhesive element AD6, they overflow on the surface of the driving assembly DA in the figures, but in fact they may not be exposed outside the driving assembly DA. For example, they may only be located in the gap between the transmission element PA3 and the driving element PA2 and in the gap between the driving element PA2 and enhancing element PA1 without overflowing.

Furthermore, as shown in FIG. 2 and FIG. 5, the optical element driving mechanism 100 may further include a position sensing assembly SA configured to sense the movement of the movable part 108. The position sensing assembly SA may include a sensing magnet MG and a sensor SE. The sensing magnet MG is fixedly disposed on the movable part 108, and the sensor SE is disposed on the circuit assembly 114. The sensor SE may be, for example, a Hall sensor or a tunnel magneto resistance sensor (TMR sensor), and the sensing magnet MG can be, for example, a multipole magnet, but they are not limited thereto.

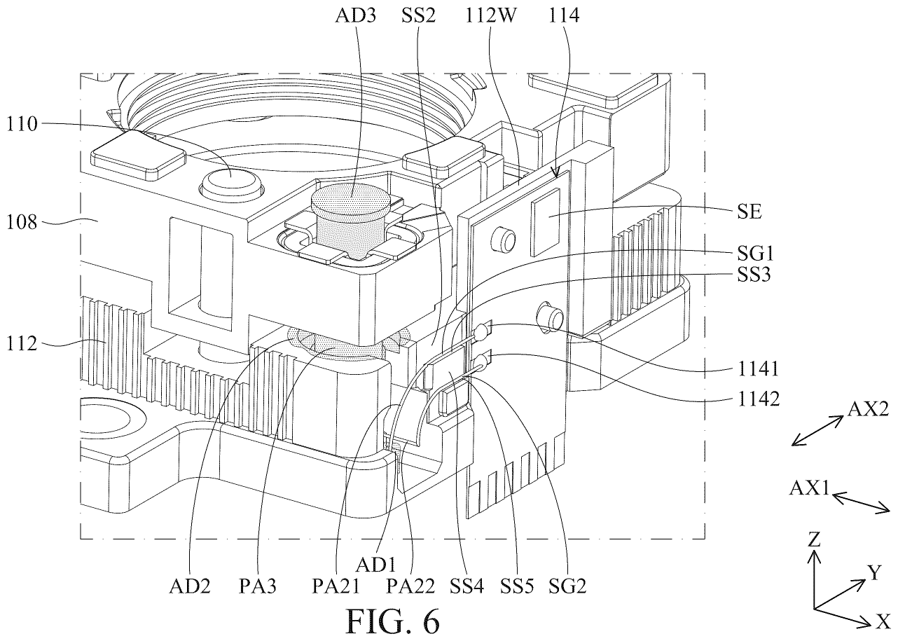

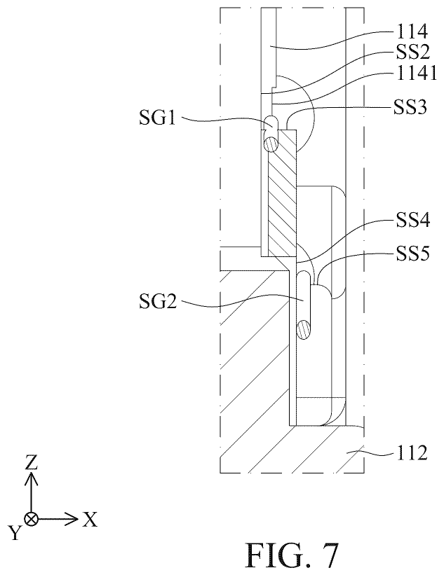

Next, please refer to FIG. 3, FIG. 4, and FIG. 6 to FIG. 7. FIG. 6 is a perspective view of a partial structure of the optical element driving mechanism 100 according to an embodiment of the present disclosure, and FIG. 7 is a cross-sectional view of a partial structure of the optical element driving mechanism 100 along the line B-B in FIG. 1 according to an embodiment of the present disclosure. In this embodiment, the driving assembly DA is electrically connected to the circuit assembly 114 and is electrically connected to an external circuit (such as an external control circuit) through the circuit assembly 114 so as to operate according to the control signal of the external circuit.

The circuit assembly 114 includes a first electrical connection portion 1141 and a second electrical connection portion 1142. The first electrical connection portion 1141 is configured to be connected to a first circuit portion PA21 of the driving assembly DA by welding, and the second electrical connection portion 1142 is configured to be connected to a second circuit portion PA22 of the driving assembly DA by welding.

The first circuit portion PA21 and the second circuit portion PA22 may be lead wires, and the first electrical connection portion 1141 and the second electrical connection portion 1142 may be, for example, soldering pads, but they are not limited thereto.

As shown in FIG. 4 and FIG. 6, a first section SG1 of the first circuit portion PA21 is located on a third surface SS3, a second section SG2 of the first circuit portion PA21 is located on a fourth surface SS4, and the second section SG2 are also located on a fifth surface SS5. The third surface SS3, the fourth surface SS4 and the fifth surface SS5 are located on the base 112, and the third surface SS3 and the fourth surface SS4 are perpendicular to each other.

When viewed along the second axis AX2, the third surface SS3 and the fifth surface SS5 do not overlap each other. When viewed along the second axis AX2, the second surface SS2 and the fourth surface SS4 also do not overlap each other.

Furthermore, as shown in FIG. 4, the first electrical connection portion 1141 and the second electrical connection portion 1142 each have a planar structure. When viewed along a direction parallel to the first electrical connection portion 1141 (such as along the second axis AX2), the first electrical connection portion 1141 is parallel to the second electrical connection portion 1142, and the first electrical connection portion 1141 is parallel to the second surface SS2 and the fourth surface SS4.

Furthermore, as shown in FIG. 6 and FIG. 7, when viewed along the Y-axis (such as along the second axis AX2), the first electrical connection portion 1141 is located on the second surface SS2 and the fourth surface, and a step structure may be formed by the second surface SS2, the third surface SS3, the fourth surface SS4 and the fifth surface SS5.

Based on the configuration of the above-mentioned step structure, the first section SG1 and the second section SG2 can be separated by the step structure, so that the operator can quickly pull the first circuit portion PA21 and the second circuit portion PA22 from the enhancing element PA1 and dispose them on the third surface SS3 and the fifth surface SS5 respectively, and then the first circuit portion PA21 and the second circuit portion PA22 are easily welded to the circuit assembly 114. That is, such a design can not only avoid the problem of the first circuit portion PA21 becoming entangled with the second circuit portion PA22, but also achieve the effect of rapid positioning.

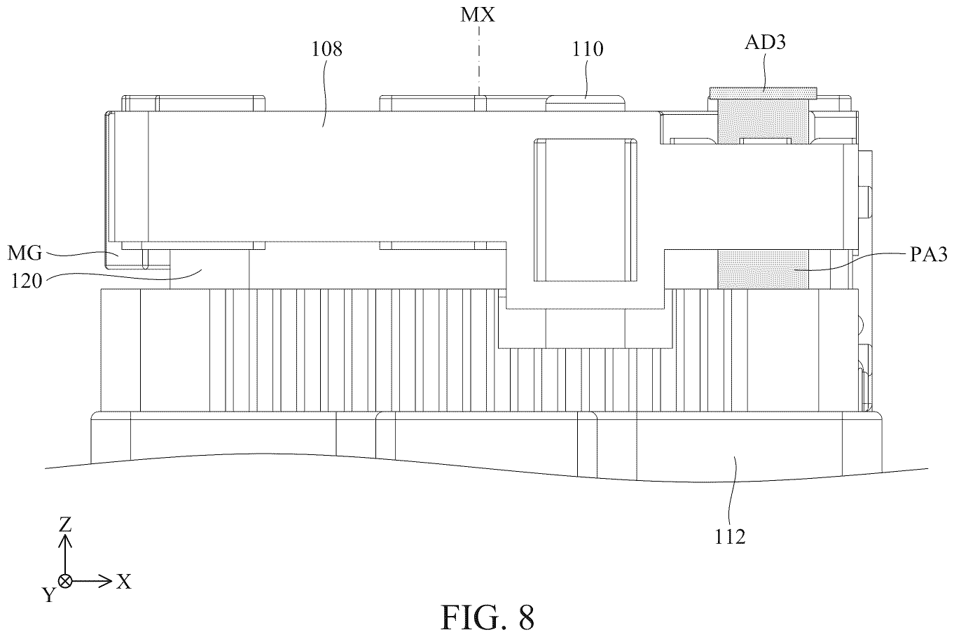

Next, please refer to FIG. 2, FIG. 5 and FIG. 8. FIG. 8 is a front view of a partial structure of the optical element driving mechanism 100 according to an embodiment of the present disclosure. In this embodiment, the optical element driving mechanism 100 further includes a protective element 110 which is disposed on the base 112 of the fixed assembly FA. The protective element 110 may be made of a metal material and have a columnar structure, such as a cylindrical structure. The protective element 110 extends along the main axis MX and passes through the movable part 108.

As shown in FIG. 2 and FIG. 5, the protective element 110 is arranged adjacent to the transmission element PA3. Specifically, as shown in FIG. 5, when viewed along the main axis MX, with the main axis MX as the origin, a first quadrant Q1, a second quadrant Q2, a third quadrant Q3 and a fourth quadrant Q4 can be defined, and when viewed along the main axis MX, the protective element 110 and the transmission element PA3 are located in the fourth quadrant Q4.

Based on the structural design and position configuration of the protective element 110, the problem that the movable part 108 breaks the transmission element PA3 when the optical element driving mechanism 100 is impacted can be avoided. That is, the protective element 110 can absorb the impact force of the movable part 108 to protect the transmission element PA3.

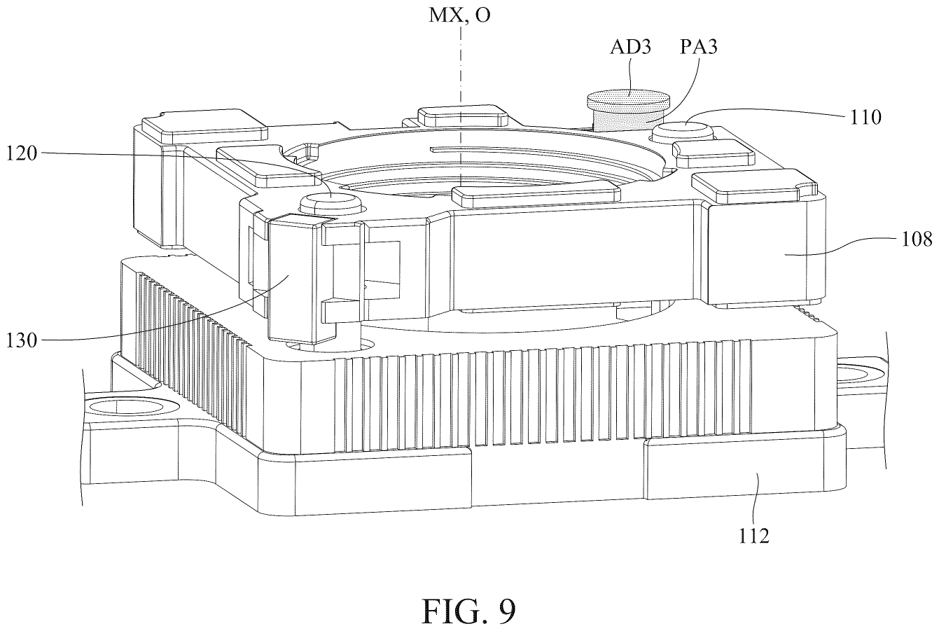

Next, please refer to FIG. 2, FIG. 5, FIG. 8 and FIG. 9. FIG. 9 is a perspective view of a partial structure of the optical element driving mechanism 100 in another view according to an embodiment of the present disclosure. As shown in FIG. 5 and FIG. 8, because the driving assembly DA is disposed on the right side of the movable part 108, when the driving assembly DA drives the movable part 108 to move along the main axis MX, the left side of the movable part 108 may be tilted towards base 112, causing unclear images.

In order to avoid the above situation, the optical element driving mechanism 100 further includes a guiding element 120 and a first stabilizing element 130 to avoid the problem of tilting of the movable part 108 during movement. As shown in FIG. 2 and FIG. 9, the guiding element 120 is disposed at the base 112 of the fixed assembly FA.

Similarly, the guiding element 120 has a columnar structure, such as a cylindrical structure, extending along the main axis MX, and the guiding element 120 is configured to pass through the movable part 108. Furthermore, the first stabilizing element 130 is fixedly disposed on the movable part 108 and corresponds to the guiding element 120.

As shown in FIG. 5, when viewed along the main axis MX, the movable part 108 may have a rectangular structure. When viewed along the main axis MX, the guiding element 120 and the first stabilizing element 130 are located at a corner CR1 of the rectangular structure. Specifically, when viewed along the main axis MX, the guiding element 120 and the first stabilizing element 130 are located at the second quadrant Q2.

Furthermore, as shown in FIG. 5, when viewed along the main axis MX, the first stabilizing element 130, the guiding element 120 and the transmission element PA3 are arranged along a diagonal line DL of the rectangular structure in sequence.

In this embodiment, the first stabilizing element 130 has magnetic material. For example, the first stabilizing element 130 is a magnet, and the first stabilizing element 130 corresponds to the guiding element 120. For example, the guiding element 120 may be made of a magnetically permeable material, such as metal.

A magnetic attraction force MF1 can be generated between the guiding element 120 and the first stabilizing element 130, causing the first stabilizing element 130 to push the movable part 108 along the diagonal line DL (as shown by the arrow in FIG. 5), and the inner wall surface of a performance PH1 of the movable part 108 can contact the guiding element 120 so as to increase the friction between the movable part 108 and the guiding element 120.

Based on such a design, the friction can avoid the aforementioned tilting problem of the movable part 108 during movement, and the friction does not affect the smoothness of the movable part 108 during movement along the main axis MX.

In conclusion, the present disclosure provides an optical element driving mechanism 100 which includes a fixed assembly FA, a movable part 108, and a driving assembly DA. The movable part 108 is movable relative to the fixed assembly FA, and the driving assembly DA is configured to drive the movable part 108 to move relative to the fixed assembly FA. Moreover, the optical element driving mechanism 100 further includes an accommodation space 112S configured to accommodate at least a portion of the driving assembly DA.

In some embodiments, the accommodation space 112S has a setting portion 112B, a first guiding portion GDP1, and a second guiding portion GDP2. The setting portion 112B is connected between the first guiding portion GDP1 and the second guiding portion GDP2, and the first guiding portion GDP1 and the second guiding portion GDP2 can be inclined surfaces, thereby guiding the driving assembly DA to be smoothly positioned and affixed to the setting portion 112B.

In addition, the optical element driving mechanism 100 may further include a first adhesive element AD1 configured to connect the enhancing element PA1 of the driving assembly DA to the setting portion 112B, and the optical element driving mechanism 100 may further include a second adhesive element AD2 which is disposed in the first opening OP1 of the base 112 and is configured to connect the transmission element PA3 of the driving assembly DA to the base 112. Based on the setting of these adhesive elements, not only can the driving assembly DA be accurately positioned on the base 112, but also the impact force applied to the driving assembly DA can be absorbed when the optical element driving mechanism 100 is impacted, so as to prevent the transmission element PA3 from being damaged.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly, having a main axis;
a movable part, configured to be connected to an optical element, wherein the movable part is movable relative to the fixed assembly; and
a driving assembly, configured to drive the movable part to move relative to the fixed assembly.

2. The optical element driving mechanism as claimed in claim 1, wherein
the optical element driving mechanism further includes an accommodation space configured to accommodate at least a portion of the driving assembly;
the accommodation space has a first opening formed on a first surface;
the accommodation space has a second opening formed on a second surface;
the first surface and the second surface are located on the fixed assembly;
the first surface and the second surface face different directions;
the first surface and the second surface are not parallel to each other;
when viewed along a first axis, the first surface overlaps at least a portion of the driving assembly;
when viewed along a second axis, the second surface does not overlap the driving assembly;
the first axis is perpendicular to the second axis.

3. The optical element driving mechanism as claimed in claim 2, wherein
the first opening is connected to the second opening;
the first opening has a first narrow portion with a tapered structure;
the second opening has a second narrow portion with a tapered structure;
when viewed along the first axis, the second narrow portion overlaps at least a portion of the driving assembly;
when viewed along the first axis, the first narrow portion overlaps at least a portion of the driving assembly;
the first narrow portion is connected to the second narrow portion.

4. The optical element driving mechanism as claimed in claim 3, wherein
the accommodation space has a setting portion;
the driving assembly is disposed on the setting portion and is located in a preset position;
the setting portion has a planar structure;
the setting portion is parallel to the first surface.

5. The optical element driving mechanism as claimed in claim 4, wherein
the accommodation space further has a first guiding portion configured to guide the driving assembly to be located in the preset position;
the first guiding portion is adjacent to the setting portion;
the first guiding portion has a first planar structure, and the first planar structure is not parallel to the setting portion;
the first guiding portion is not perpendicular to the setting portion.

6. The optical element driving mechanism as claimed in claim 5, wherein
the accommodation space further has a second guiding portion configured to guide the driving assembly to be located in the preset position;
the second guiding portion is adjacent to the setting portion;
the second guiding portion has a second planar structure, and the second planar structure is not parallel to the setting portion;
the second guiding portion is not perpendicular to the setting portion;
the first guiding portion and the second guiding portion are not parallel to each other;
the first guiding portion and the second guiding portion are not perpendicular to each other;
the optical element is not located in the accommodation space.

7. The optical element driving mechanism as claimed in claim 6, wherein
the driving assembly includes a driving element, a transmission element, and an enhancing element;
the driving element is configured to generate a driving force;
the transmission element is configured to transmit the driving force;
the driving force is transmitted to the movable part through the transmission element;
the transmission element has a long strip-shaped structure extending along the main axis;
the enhancing element corresponds to the driving element to enhance the intensity of the driving force;
when viewed along the first axis, the first surface overlaps at least a portion of the transmission element;
when viewed along the second axis, the second surface does not overlap at least a portion of the transmission element.

8. The optical element driving mechanism as claimed in claim 7, wherein
the optical element driving mechanism further includes a first adhesive element, and the driving assembly is connected to the setting portion via the first adhesive element;
the first adhesive element is in direct contact with the first guiding portion;
the first adhesive element is in direct contact with the second guiding portion;
the first adhesive element is in direct contact with the enhancing element.

9. The optical element driving mechanism as claimed in claim 8, wherein
the optical element driving mechanism further includes a second adhesive element, and the driving assembly is connected to the first opening via the second adhesive element;
the second adhesive element is in direct contact with the first surface;
the second adhesive element is in direct contact with the first narrow portion;
the second adhesive element is in direct contact with the transmission element;
the first surface is not perpendicular to the extending direction of the transmission element.

10. The optical element driving mechanism as claimed in claim 9, wherein
the optical element driving mechanism further includes a third adhesive element, and the driving assembly is connected to the fixed assembly through the third adhesive element;
the third adhesive element is in direct contact with a first adhesive portion of the fixed assembly;
the first adhesive portion has a planar structure and faces the driving assembly;
the third adhesive element is in direct contact with a second adhesive portion of the driving assembly;
the second adhesive portion has a planar structure facing the first adhesive portion;
the first adhesive portion and the second adhesive portion are not parallel to each other.

11. The optical element driving mechanism as claimed in claim 10, wherein
the optical element driving mechanism further includes a central assembly disposed between the transmission element and the movable part;
the driving force is transmitted to the movable part through the transmission element and the central assembly in sequence;
the central assembly includes a contact member which corresponds to the driving assembly;
the central assembly further includes a force-applying member which applies a supporting force on the contact member.

12. The optical element driving mechanism as claimed in claim 11, wherein
the force-applying member has a first extending outward portion which is disposed between the contact member and the movable part;
the force-applying member further has a second extending outward portion which is disposed between the contact member and the movable part;
the force-applying member further has an extending inward portion, and the first extending outward portion is connected to the second extending outward portion via the extending inward portion;
a maximum distance between the first extending outward portion and the movable part is different from a minimum distance between the extending inward portion and the movable part;
the maximum distance between the first extending outward portion and the movable part is less than the minimum distance between the extending inward portion and the movable part.

13. The optical element driving mechanism as claimed in claim 12, wherein
the optical element driving mechanism further includes a fourth adhesive element;
the central assembly is connected to the movable part via the fourth adhesive element;
the fourth adhesive element is in direct contact with the force-applying member;
the fourth adhesive element is in direct contact with the extending inward portion;
at least a portion of the fourth adhesive element is located in a gap formed between the extending inward portion and the movable part.

14. The optical element driving mechanism as claimed in claim 13, wherein
the first adhesive element and the second adhesive element are made of the same material;
the second adhesive element and the third adhesive element are made of the same material;
the third adhesive element and the fourth adhesive element are made of the same material;
the first adhesive element and the fourth adhesive element are made of the same material.

15. The optical element driving mechanism as claimed in claim 14, wherein
the driving assembly further includes a fifth adhesive element and a sixth adhesive element;
the transmission element is connected to the driving element via the fifth adhesive element;
the enhancing element is connected to the driving element via the sixth adhesive element;
the young's modulus of the fifth adhesive element is the same as the young's modulus of the sixth adhesive element;
the young's modulus of the fifth adhesive element is different from the young's modulus of the first adhesive element;
the young's modulus of the fifth adhesive element is greater than the young's modulus of the first adhesive element.

16. The optical element driving mechanism as claimed in claim 15, wherein
the optical element driving mechanism further includes a circuit assembly;
the driving assembly is electrically connected to the circuit assembly and is electrically connected to an external circuit through the circuit assembly;
the circuit assembly includes a first electrical connection portion and a second electrical connection portion;
the first electrical connection portion is configured to be connected to a first circuit portion of the driving assembly;
the second electrical connection portion is configured to be connected to a second circuit portion of the driving assembly;
a first section of the first circuit portion is located on a third surface;
a second section of the first circuit portion is located on a fourth surface;
the second section is located on a fifth surface;
the third surface, the fourth surface and the fifth surface are located on the fixed assembly;
the third surface and the fourth surface are perpendicular to each other.

17. The optical element driving mechanism as claimed in claim 16, wherein
when viewed along the second axis, the third surface and the fifth surface do not overlap each other;
when viewed along the second axis, the second surface and the fourth surface do not overlap each other;
the first electrical connection portion and the second electrical connection portion each have a planar structure;
when viewed in a direction parallel to the first electrical connection portion, the first electrical connection portion is parallel to the second electrical connection portion;
the first electrical connection portion is parallel to the second surface and the fourth surface;
when viewed along the second axis, the first electrical connection portion is located between the second surface and the fourth surface;
the second surface, the third surface and the fourth surface form a step structure.

18. The optical element driving mechanism as claimed in claim 7, wherein
the optical element driving mechanism further includes a protective element which is disposed on the fixed assembly;
the protective element has a columnar structure extending along the main axis;
the protective element is configured to pass through the movable part;
when viewed along the main axis, with the main axis as the origin, a first quadrant, a second quadrant, a third quadrant and a fourth quadrant are defined;
when viewed along the main axis, the protective element and the transmission element are located in the fourth quadrant.

19. The optical element driving mechanism as claimed in claim 18, wherein
the optical element driving mechanism further includes a guiding element which is disposed at the fixed assembly;
the guiding element has a columnar structure extending along the main axis;
the guiding element is configured to pass through the movable part;
the optical element driving mechanism further includes a first stabilizing element which is disposed on the movable part;
the first stabilizing element has magnetic material;
the first stabilizing element corresponds to the guiding element.

20. The optical element driving mechanism as claimed in claim 19, wherein
when viewed along the main axis, the guiding element and the first stabilizing element are located in the second quadrant;
when viewed along the main axis, the movable part has a rectangular structure;
when viewed along the main axis, the guiding element and the first stabilizing element are located at a corner of the rectangular structure;
when viewed along the main axis, the first stabilizing element, the guiding element and the transmission element are arranged along a diagonal line of the rectangular structure in sequence.
